(19) United States
(12) Patent Application Publication
(10) Pub. No.: US 2004/0195485 A1
(43) Pub. Date: Oct. 7, 2004

(54) Hanger

(76) Inventor: Alvin Kaplan, Armonk, NY (US)

Correspondence Address: DARBY & DARBY P.C., P. O. BOX 5257, NEW YORK, NY, 10150-5257, US

(21) Appl. No.: 10/807,521

(22) Filed: Mar. 22, 2004

Related U.S. Application Data
(60) Provisional application No. 60/456,612, filed on Mar. 21, 2003.

(51) Int. Cl. B42F 13/00; A47B 97/04

(52) U.S. Cl. 248/340; 248/339; 248/303

(57) ABSTRACT

An article hanger is provided that includes a hanging element and a shaft having a top end and a bottom end. The hanging element is disposed on the top end of a support shaft. The article hanger also includes a support element disposed on the bottom end of the support shaft. An article is rolled around the shaft to form a cylinder and the support element supports an end of the cylinder so that the article is suspended vertically. The support element can be ring shaped or a sold disk. Additionally, the support element can be pivotally connected to the shaft whereby the support element pivots between a first position approximately parallel to the shaft and a second position approximately perpendicular to the shaft. The pivotally connected support element can further include a living hinge between the support element and the shaft.

### RELATED APPLICATIONS

This application claims the priority of U.S. Provisional Application No. 60/456,612, filed on Mar. 21, 2003 which is hereby incorporated hereby by reference in its entirety.

### BACKGROUND OF THE INVENTION

1. Field of the Invention

The present invention relates to a hanger for supporting round fold articles vertically. More specifically, the hanger supports the round fold article and prevents the article from unfolding while suspending the article vertically.

2. Discussion of the Related Art

Various types of hangers are well known in the art such as, hangers that support an article draped over its arms or that support an article folded over a lower arm. Also well known in the art are devices that support an article using a passage formed through the packaging surrounding the article.

FIG. 1 illustrates a prior art hanger 20 for a rectangular fold article. A rectangular folded article is defined as an article that is folded in a manner such that the folded article has a rectangular shape. The hanger 20 has a hook portion 22 connected to a neck 24, which is connected to a top arm 26. Top arm 26 is connected to a bottom arm 28. A rectangular fold article 10 is folded over bottom arm 28 so rectangular fold article 10 is supported by hanger 20. Rectangular fold article 10 is then secured in place to prevent it from sliding off hanger 20. One prior art means used to secure the article was to encircle the article, below the hanger, with a strap 30. Strap 30 surrounds the halves of rectangular fold article 10 and prevents them from separating slipping off bottom arm 28. Utilizing strap 30 allows a majority of the article to be exposed so a potential purchaser of the article can view and touch the fabric of the article. Purchasers typically prefer to touch the material of an article they wish to buy. The nature of the article's fabric is one of the factors a purchaser typically considers when buying an article. However, one disadvantage of the rectangular fold hanger is that the horizontal extent of the hanger is dictated by a folded width “X” of the article. Thus, the wider the article, the longer the arms of the hanger must be to accommodate the article. An increase in the size of the article (folded width X) would require an increase in the width of the hanger, which increases the amount of space required to display the article.

To reduce the amount of retail space required to display an article, the article can be circularly folded. A circular fold article is defined as an article that is rolled into a cylindrical shape. FIG. 2 illustrates prior art for supporting a circular fold article 40 comprising a bag 50 having a top end 52 and a bottom end 54. Article 40 is inserted lengthwise into the bag 50. Top end 52 is typically sealed and includes a vertically extruding hanger strip 56 having a central opening 58 through which an article hang rod 59 is inserted. A width “Y” of circular fold article 40 is less than the width “X” of rectangular fold article 10, wherein X>Y or, typically, X>>Y. Thus, a circular fold article requires less retail space than a rectangular fold article to display the same size article. The circular fold article must be fully enclosed to provide support for the bottom of the article. However, one disadvantage of enclosing the article is that a potential purchaser of the article cannot touch the fabric of the article. As mentioned above, purchasers typically prefer to touch the material of an article they wish to buy and enclosing the article prevents tactile contact. Thus, potential purchasers are dissuaded from purchasing the enclosed circular fold article.

Accordingly, there is a need in the art to reduce the displayed size of a hanging article while allowing a potential purchaser to touch the article.

### SUMMARY OF THE INVENTION

An article hanger is provided that includes a hanging element and a shaft having a top end and a bottom end. The hanging element is disposed on the top end of a support shaft. The article hanger also includes a support element disposed on the bottom end of the support shaft. An article is rolled around the shaft to form a cylinder and the support element supports an end of the cylinder so that the article is suspended vertically. Additionally, a strap can be wrapped around the article to prevent the article from unrolling and falling off the shaft.

The support element can have numerous embodiments. The support element can be ring shaped or a sold disk. The solid disk includes an outer ring and a flat portion. Additionally, the support element can be pivotally connected to the shaft whereby the support element pivots between a first position approximately parallel to the shaft and a second position approximately perpendicular to the shaft. The pivotally connected support element can further include a notch dimensioned to receive the shaft so the pivotally connected support element can pivot flush with the shaft in the first position.

An additional feature can be used in conjunction with any embodiment of the present invention. The article hanger can further include a header element disposed on the shaft between the hanging element and the article. The header element can be trapezoidal or rectangular in cross section. Advertising or promotional material can be printed on a face of the header element to assist in identifying the article.

### BRIEF DESCRIPTION OF THE DRAWING FIGURES

The above and still further objects, features and advantages of the present invention will become apparent upon consideration of the following detailed description of a specific embodiment thereof, especially when taken in conjunction with the accompanying drawings wherein like reference numerals in the various figures are utilized to designate like components, and wherein:

FIG. 1 is a perspective view of a prior art hanger for a rectangular fold article;

FIG. 2 is a perspective view of prior art hanging means for a circular fold article;

FIG. 3a is a perspective view of one embodiment of the hanger of the present invention;

FIG. 3b is a perspective view of the hanger of FIG. 3a with a hanging article;

FIG. 4a is a perspective view of another embodiment of the present invention;

FIG. 4b is a side view of the embodiment illustrated in FIG. 4a;

FIG. 4c is a perspective view of the hanger of FIG. 4a with a hanging article;

FIG. 5a is a perspective view of another embodiment of the present invention;

FIG. 5b is a perspective view of the embodiment illustrated in FIG. 5a illustrating the support element in an alternate position;

FIG. 5c is a perspective view of the hanger of FIG. 5a with a hanging article;

FIG. 6 is a perspective view of another embodiment of the present invention; and

FIG. 7 is a perspective view of another embodiment of the present invention.

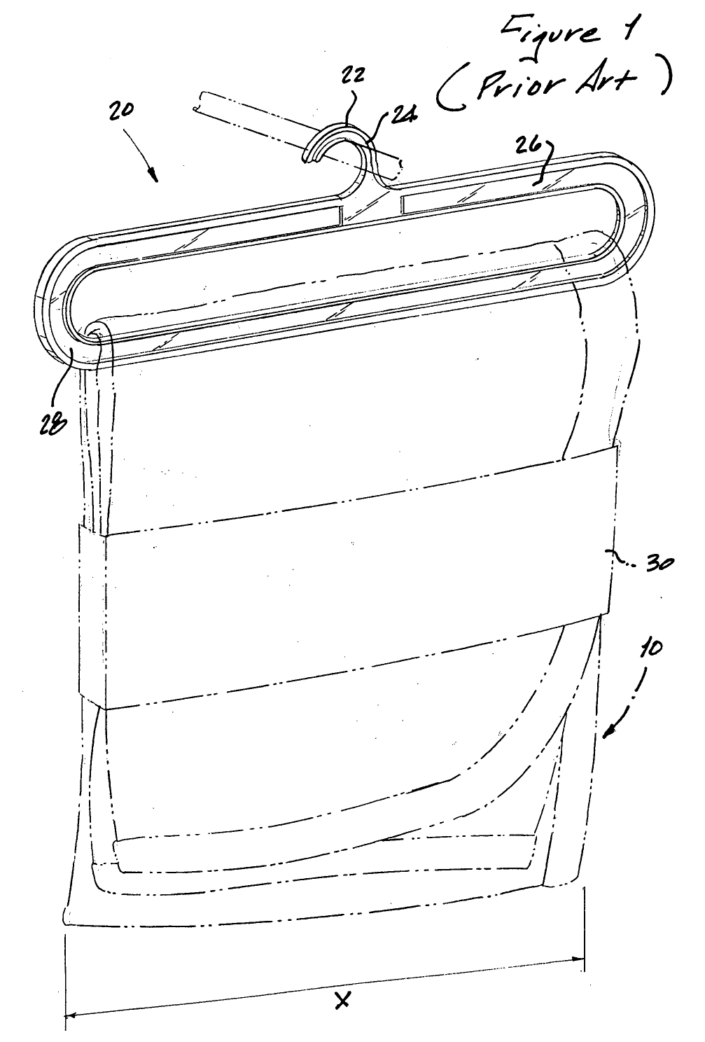

### DETAILED DESCRIPTION OF THE INVENTION

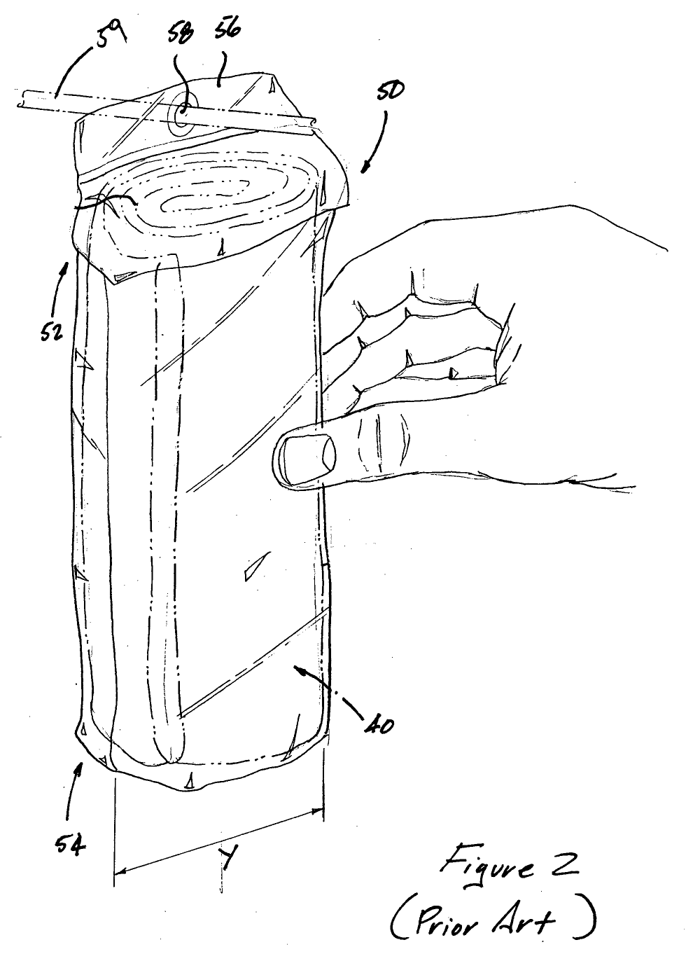

FIGS. 3aand 3bshow a hanger made in accordance with the present invention. Thus, an article hanger 100 comprises a hanging element 102 and a shaft 104 having a top end 106 and a bottom end 108. Hanging element 102 is disposed on top end 106 of shaft 104. Article hanger 100 also includes a support element 110 disposed on bottom end 108 of shaft 104. In use, an article is rolled around shaft 104 to form cylinder 112 and support element 110 supports an end of article 112 such that the cylinder is suspended vertically.

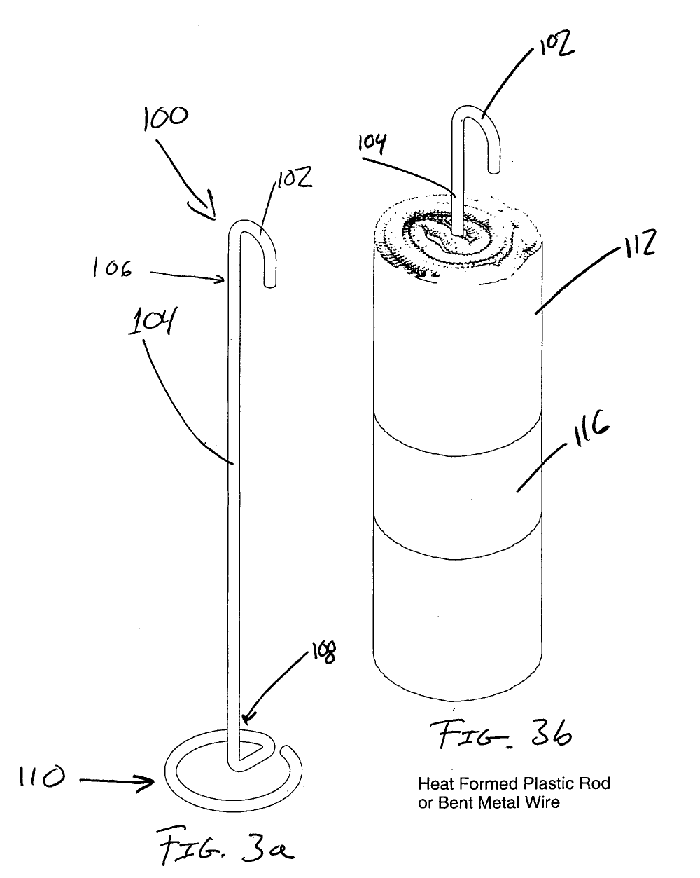

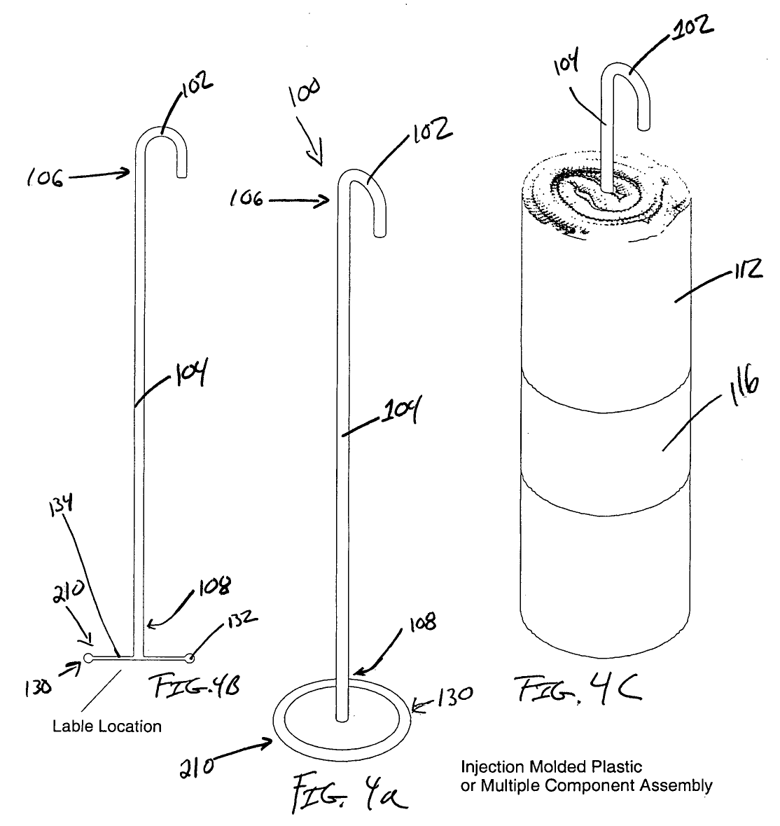

Referring now to FIGS. 3a, 4a, and 5a support element 110 may have numerous embodiments. FIG. 3a illustrates a unitary hanger where the support element 110 is an extrusion of the shaft 104 and is circular. FIGS. 4a to 4c, illustrate another embodiment of the present invention. Support element 210 is a sold disk 130 including an outer raised circumferential ring 132 and a flat portion 134.

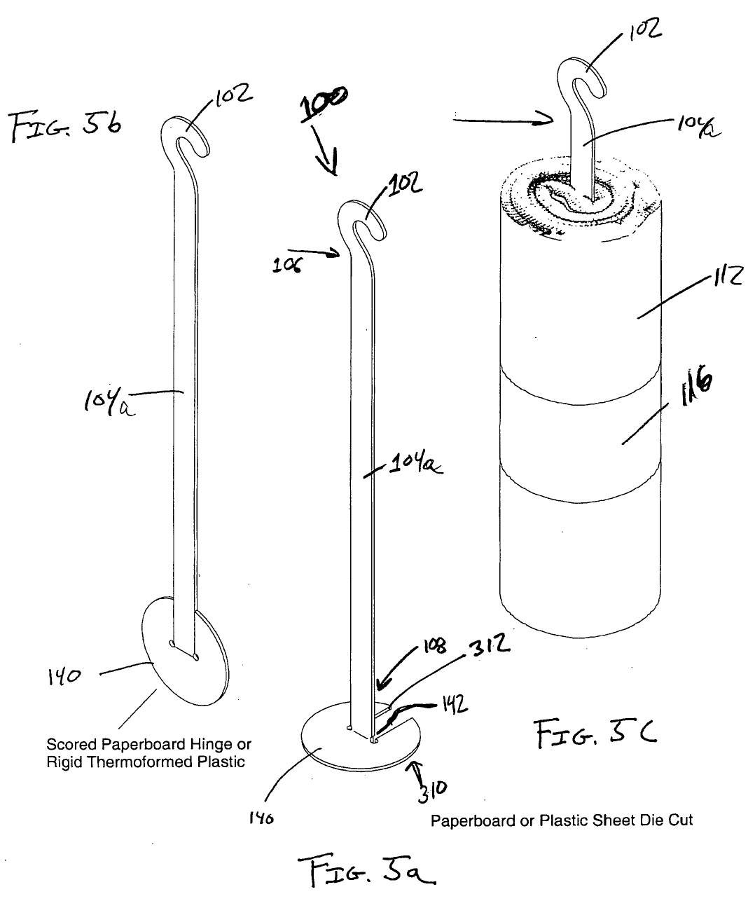

FIGS. 5a to 5c illustrate another embodiment of the present invention. Support element 310 is pivotally connected to a flat shaft 104a. Support element 310 pivots between a first position approximately parallel to flat shaft 104a and a second position approximately perpendicular to flat shaft 104a. The pivotal connection can include a living hinge 142 between flat shaft 104a and support element 310 or any other hinge or pivotal joint known to those of skill in the art. Thus, pivotally connected support element 310 can pivot approximately flush with flat shaft 104a. FIG. 5a illustrates pivotally connected support element 310 in the second position and FIG. 5b illustrates pivotally connected support element 310 in the first position.

Additionally, support element 310 can include a notch 312 sized to receive shaft 104 once support element 310 is pivoted parallel to shaft 104. This allows hanger 100 to be stored and shipped flat if the hanger is manufactured separately from the article to be hung. One or more notches 312 can be located anywhere on support element 310 so the pivotal connection can pivot in one or more directions and support element 310 can pivot flush with shaft 104. Notch 312 can be shaped similar to the shape of shaft 104, or any other shape to allow shaft 104 to be received.

Further, support elements 110, 210, 310 can be any shape and size. Support elements 110, 210, 310 can be, for example, circular, rectangular, oval, elliptical, triangular, and polygonal. Additionally, support elements 110, 210, 310 can be sized to approximate the size of article 112 once folded or can be larger or smaller depending on the article.

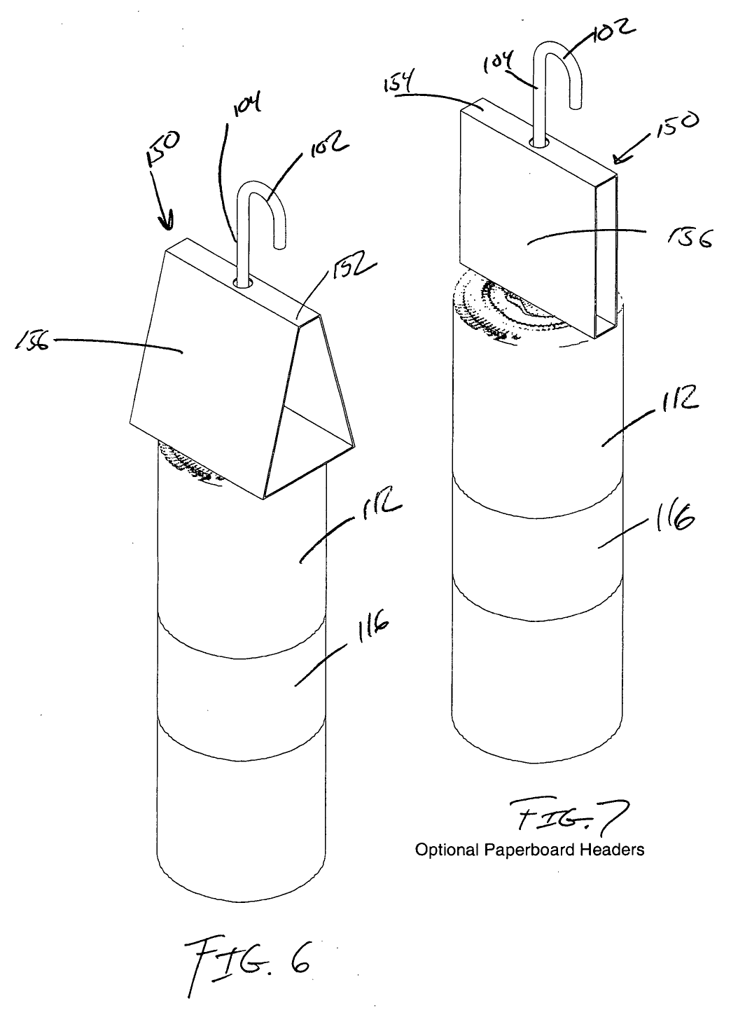

FIGS. 6 and 7 illustrate an additional feature to be used in conjunction with any of the above embodiments. Article hanger 100 can further include a header element 150, wherein header element 150 is disposed on shaft 104 between hanging element 102 and article 112. Header element 150 can be trapezoidal or rectangular in cross section. FIG. 6 illustrates trapezoidal header element 152 and FIG. 7 illustrates rectangular header element 154. Product information can be printed on face 156 of header element 150. Both header elements are provided with aligned centrally located openings on the top and bottom surfaces through which shaft 104 extends to maintain the header element on the shaft.

Additionally, FIGS. 3b, 4c, 5c, 6 and 7 illustrate a strap 116 wrapped around article 112 to prevent the article from unwrapping from shaft 104.

Thus, while there have been shown, described, and pointed out fundamental novel features of the invention as applied to a preferred embodiment thereof, it will be understood that various omissions, substitutions, and changes in the form and details of the devices illustrated, and in their operation, may be made by those skilled in the art without departing from the spirit and scope of the invention. For example, it is expressly intended that all combinations of those elements and/or steps which perform substantially the same function, in substantially the same way, to achieve the same results are within the scope of the invention. Substitutions of elements from one described embodiment to another are also fully intended and contemplated. It is also to be understood that the drawings are not necessarily drawn to scale, but that they are merely conceptual in nature. It is the intention, therefore, to be limited only as indicated by the scope of the claims appended hereto.

What is claimed is:

1) A hanger comprising:
a hanging element;
a shaft having a top end and a bottom end, the hanging element disposed on the top end of the shaft;
a support element disposed on the bottom end of the shaft and extending outwardly therefrom to provide a support base;
wherein an article may be rolled around the shaft to form a cylinder, whereby the base supports the article in a vertical position.

2) The hanger as defined in claim 1, wherein the support element is ring shaped.

3) The hanger as defined in claim 1, wherein the support element is a sold disk.

4) The hanger as defined in claim 1, wherein the support element is pivotally connected to the shaft and the support element pivoting between a first position approximately parallel to the shaft and a second position approximately perpendicular to the shaft.

5) The hanger as defined in claim 4, wherein the pivotally connected support element comprises a notch dimensioned to receive the shaft.

6) The hanger as defined in claim 1, further comprising a header element, wherein the header element is disposed on the shaft between the hanging element and the article.

7) The hanger as defined in claim 6, wherein the header element is trapezoidal in cross section.

8) The hanger as defined in claim 6, wherein the header element is rectangular in cross section.

9) The hanger as defined in claim 1, further comprising a strap encircling the article.
